(19) United States
(12) Patent Application Publication
(10) Pub. No.: US 2014/0002258 A1
(43) Pub. Date: Jan. 2, 2014

(54) SMART TIRE PRESSURE SENSOR, SMART TIRE PRESSURE MONITORING SYSTEM USING SAME

(71) Applicant: Hsin-Chien CHEN, Taichung City (TW)

(72) Inventor: Hsin-Chien CHEN, Taichung City (TW)

(21) Appl. No.: 14/012,206

(22) Filed: Aug. 28, 2013

Related U.S. Application Data
(63) Continuation-in-part of application No. 13/087,006, filed on Apr. 14, 2011.

(51) Int. Cl. B60C 23/04

(52) U.S. Cl. CPC B60C 23/0486
USPC 340/447

(57) ABSTRACT

A smart tire pressure monitoring system includes a plurality of smart tire pressure sensors respectively installed in one respective tire of a vehicle for communication with an electronic control unit in the vehicle through a wireless communication protocol. Each smart tire pressure sensor includes a LF receiver for receiving a low frequency communication signal from the electronic control unit, an encoding identification unit for recognizing the low frequency communication signal and fetching and modulating a corresponding ID code, and a RF transmitter for transmitting the modulated ID code to the electronic control unit to establish communication.

### BACKGROUND OF THE INVENTION

1. Technical Field

The present invention relates to tire pressure monitoring technology, and more particularly to a smart tire pressure sensor and a smart tire pressure monitoring system using smart tire pressure sensors that is capable of automatically learning and matching with an electronic control unit of vehicle, enabling the electronic control unit to obtain the tire pressure data of every tire of the vehicle smoothly.

2. Description of Related Art

A conventional tire pressure monitoring system includes a tire pressure sensor installed in each tire on a vehicle and adapted to detect the air pressure and temperature of the respective tire and to transmit the detected data through a transmitting device therein to an electronic control unit of vehicle, enabling the driver to know the current tire pressure data through a display.

However, different tire pressure monitoring systems from different providers use different encoding systems to establish communication between the tire pressure sensors and the electronic control unit. Consequently, vehicles made by different manufacturers in different years have their tire pressure monitoring systems be equipped with different encoders. The electronic control unit and tire pressure sensors of a tire pressure monitoring system in a vehicle already have a predetermined encoder system programmed therein before leaving the factory, and this built-in program is not editable. Thus, tire pressure sensors from one provider cannot establish communication with an electronic control unit from another provider. In consequence, the future maintenance or update of the encoder system of the smart tire pressure sensors will encounter a big problem.

There are commercial tire pressure sensors having built therein multiple ID codes to fit different encoder systems of different electronic control units. However, most of these tire pressure sensors adopt a switching technique to select the desired ID code, and some other of these tire pressure sensors need to be connected to a computer or microprocessor by a signal line for receiving an ID code. Thus, the maintenance worker must make sure of the encoder system of the electronic control unit prior to installation of a tire pressure sensor. Because a tire pressure sensor is to be mounted in the steel wheel rim at the inner side of the tire, the maintenance worker needs to discharge the air of the tire and remove the tire from the steel wheel rim and then to select the encoder system again in case of a wrong ID code. This encoder system installation procedure is complicated and inconvenient.

### SUMMARY OF THE INVENTION

The invention has been accomplished under the circumstances in view. It is therefore the main object of the present invention to provide a smart tire pressure sensor and a smart tire pressure monitoring system using same, wherein the smart ire pressure sensor automatically recognizes the low frequency communication signal provided by an electronic control unit and provides a corresponding ID code to the electronic control unit to establish communication, enabling the electronic control unit to obtain the tire pressure value of each tire.

To achieve this and other objects of the present invention, a smart tire pressure sensor of the invention comprises a microcontroller, a pressure sensor electrically connected to the microcontroller and adapted for sensing the tire pressure value of a tire, a LF receiver electrically connected to the microcontroller and adapted for receiving a low frequency communication signal from an electronic control unit in a vehicle, a RF transmitter electrically connected to the microcontroller, a battery unit electrically connected to the microcontroller to provide the smart tire pressure sensor with the necessary working electricity, an encoding identification unit electrically connected to the microcontroller and having installed therein a plurality of predetermined ID codes and controllable by the microcontroller to recognize the low frequency communication signal received by the LF receiver and to fetch and modulate one respective ID code for transmission to the electronic control unit by the RF transmitter to establish communication with the electronic control unit, and an accelerometer sensor electrically connected to the microcontroller and adapted for sensing an acceleration value of the tire and stopping the encoding identification unit from operation upon detection of the acceleration value.

Thus, a smart tire pressure sensor in accordance with the present invention can be used in any vehicle to build up a smart tire pressure monitoring system.

without limitation. After. communication between the smart tire pressure sensor and the electronic control unit of the vehicle and moving of the vehicle, the communication between the smart tire pressure sensor and the electronic control unit is locked, avoiding interference from the electronic control unit of any other vehicle.

### BRIEF DESCRIPTION OF THE DRAWINGS

The invention as well as a preferred mode of use, further objectives and advantages thereof will be best understood by reference to the following detailed description of illustrative embodiment when read in conjunction with the accompanying drawings, wherein:

FIG. 1 is a schematic drawing illustrating a smart tire pressure monitoring system in accordance with the present invention.

FIG. 2 is an elevational view of a smart tire pressure sensor for smart tire pressure monitoring system in accordance with the present invention.

FIG. 3 is a circuit block diagram of the smart tire pressure monitoring system in accordance with the present invention.

FIG. 4 is a circuit block diagram of the encoding identification unit in each smart tire pressure sensor of the smart tire pressure monitoring sys accordance with the present invention.

### DETAILED DESCRIPTION OF THE INVENTION

Prior to reading the description of a preferred embodiment provided hereinafter for illustrating the concept of the present invention, it is to be understood that the components of the embodiment shown in the accompanying drawings are depicted for the sake of easy explanation and need not to be made to exact scale.

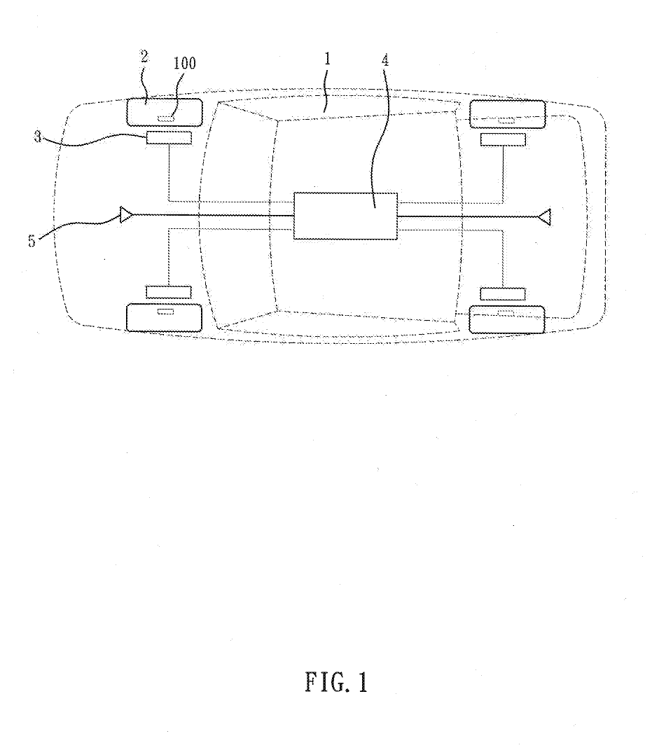

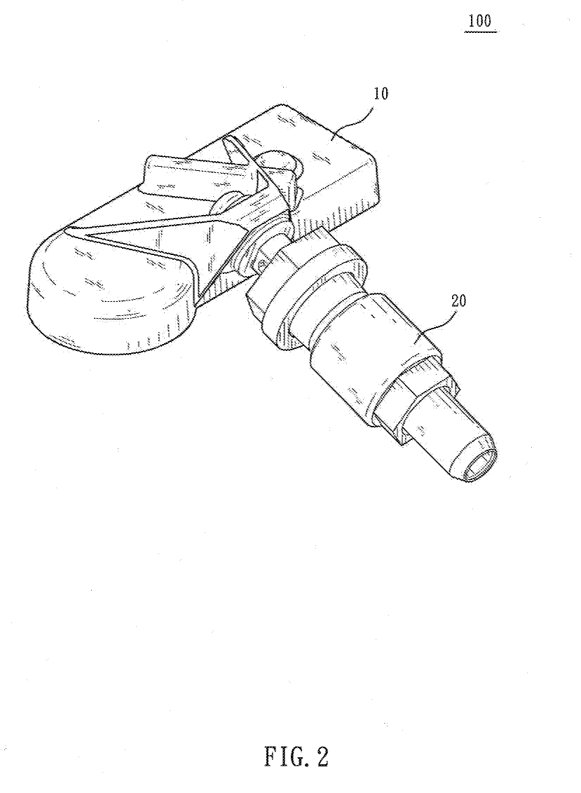

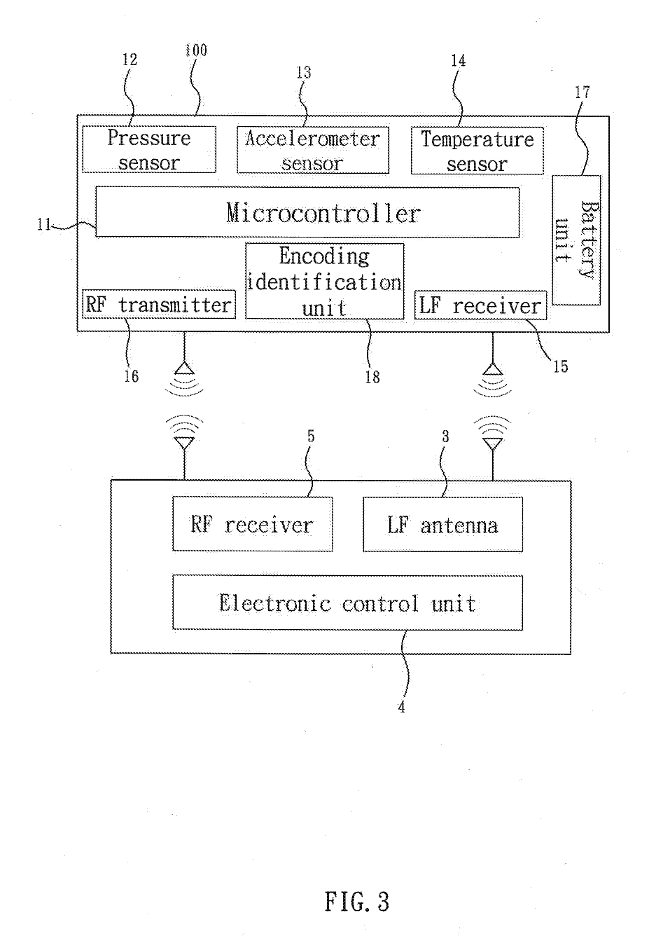

Referring to FIGS. 1-3, a smart tire pressure monitoring system in accordance with the present invention is shown installed in a vehicle 1. In this embodiment, the vehicle 1 is a car having four tires 2. The smart tire pressure monitoring system comprises a smart tire pressure sensor 100 installed in each tire 2, an electronic control unit 4 mounted in the vehicle 1 at a selected location (for example, the dashboard), a LF antenna 3 mounted in the vehicle 1 corresponding to one respective tire 2 and electrically connected to the electronic control unit 4, and a plurality of RF receiver 5 mounted in the vehicle 1 and electrically connected to the electronic control unit 4.

Each smart tire pressure sensor 100 comprises a housing 10, an air valve 20 mounted at one side of the housing 10, and a microcontroller 11, a pressure sensor 12, an accelerometer sensor 13, a temperature sensor 14, a LF receiver 15, a RF transmitter 16, a battery unit 17 and an encoding identification unit 18 mounted within the housing 10.

The pressure sensor 12 is electrically connected to the microcontroller 11 and adapted to detect the tire pressure value of the respective tire 2. The accelerometer sensor 13 is electrically connected to the microcontroller 11 and adapted to detect the acceleration value of the respective tire 2. The temperature sensor 14 is electrically connected to the microcontroller 11 and adapted to detect the temperature value of the respective tire 2. The battery unit 17 and the encoding identification unit 18 are respectively electrically connected to the microcontroller 11.

The LF receiver 15 is electrically connected to the microcontroller 11 and adapted to receive a low frequency communication signal from one respective LF antenna 3 to wake up the respective smart tire pressure sensor 100. Upon receipt of a low frequency communication signal from the respective LF antenna 3, the LF receiver 15 converts the signal into an induction voltage to wake up the microcontroller 11. The low frequency in this embodiment is of 125 KHz. Further, the LF antennas 3 can be independent devices outside the vehicle 1 adapted for waking up the smart tire pressure sensors 100.

The encoding identification unit 18 has built therein a plurality of D codes, and is electrically connected to the microcontroller 11. After having been woken up by a low frequency communication signal, the microcontroller 11 fetches and modulates the corresponding ID code from the encoding identification unit 18, and then transmits the modulated ID code to the electronic control unit 4 in the vehicle 1 via the RF transmitter 16. Upon receipt of the ID code, the electronic control unit 4 establishes communication with the respective smart tire pressure sensor 100 to obtain the detected tire pressure, temperature and speed data of the respective tire 2 from the respective smart tire pressure sensor 100.

Further, if the accelerometer sensor 13 detects an acceleration value of the respective tire 2 (i.e., the vehicle 1 starts to move) during operation of the RF transmitter 16 of each smart tire pressure sensor 100 to transmit a modulated signal to the electronic control unit 4, the encoding identification unit 18 immediately runs a locking procedure to stop working, preventing communication with other vehicles. Further, the acceleration value of the vehicle 1 can be, for example, 20 km/hour.

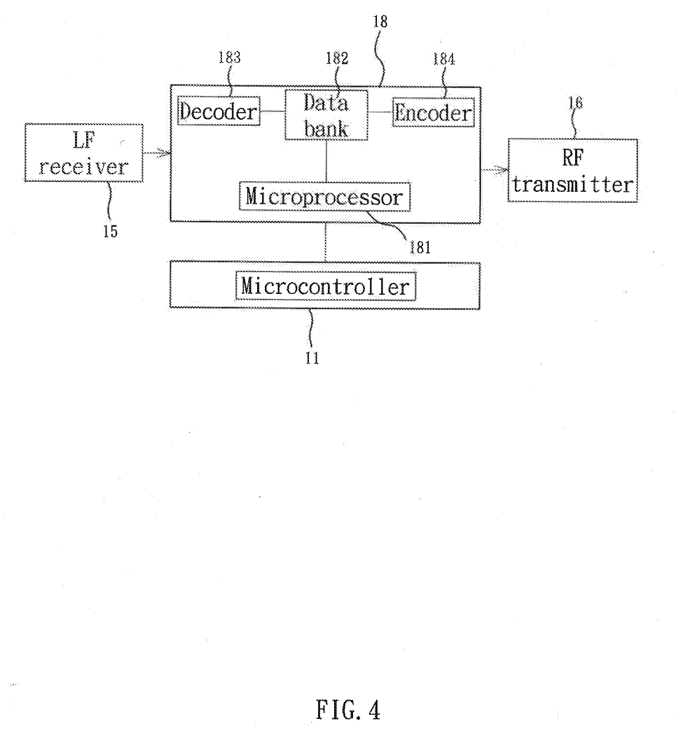

FIG. 4 is a circuit block diagram of the encoding identification unit 18 in each smart tire pressure sensor 100 of the smart tire pressure monitoring system in accordance with the present invention. As illustrated, the encoding identification unit 18 comprises a microprocessor 181, a data bank 182, a decoder 183, and an encoder 184. When the LF receiver 15 receives a low frequency communication signal, the decoder 183 amplifies the signal and converts it into a digital ID code for enabling the microprocessor 181 to recognize its waveform and to fetch the corresponding ID code from the data bank 182, for example, the ID code of A123 of the electronic control unit 4. After fetched the ID code of A123 from the data bank 182, the microprocessor 181 controls the encoder 184 to encode this ID code into a modulated signal and then controls the RF transmitter 16 to send out this modulated signal.

Hereinafter, we explain how each smart tire pressure sensor 100 and the electronic control unit 4 of the vehicle 1 to restart the matching procedure:

At first, each tire 2 and each respective smart tire pressure sensor 100 are properly installed in the vehicle 1, and then the electronic control unit 4 is operated to transmit a low frequency communication signal through each LF antenna 3 to each smart tire pressure sensor 100 to wake up or trigger the microcontroller 11 of each smart tire pressure sensor 100, enabling the encoding identification unit 18 of each smart tire pressure sensor 100 to fetch and modulate the corresponding ID code and then to transmit the modulated ID code through the respective RF transmitter 16 to the RF receiver 5, and thus the electronic control unit 4 can establish communication with each smart tire pressure sensor 100 to automatically determine the location of each tire 2 after receipt of the respective ID code.

It is particularly worth mentioning that to avoid signal interference by other vehicles during matching, the encoding identification unit 18 of each smart tire pressure sensor 100 immediately enters a locking procedure to stop operation after establishment of communication with the electronic control unit 4 and after the accelerometer sensor 13 detected an acceleration value, prohibiting the respective smart ire pressure sensor 100 from establishing communication with the electronic control unit 4 of any other vehicle and avoiding losing contact with the electronic control unit 4 of the vehicle 1.

In conclusion, the smart tire pressure monitoring system of the invention enables each smart tire pressure sensor to automatically recognize the ID of the electronic control unit and provides its ID code to the electronic control unit to establish communication, so that the electronic control unit can obtain the tire pressure value of each tire. Thus, the invention can be used in different vehicles of different models or from different providers.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A smart tire pressure sensor, comprising:
a microcontroller;
a pressure sensor electrically connected to said microcontroller and adapted for sensing the tire pressure value of a tire;
a LF receiver electrically connected to said microcontroller and adapted for receiving a low frequency communication signal;
a RF transmitter electrically connected to said microcontroller;
a battery unit electrically connected to said microcontroller to provide the smart tire pressure sensor with the necessary working electricity;
an encoding identification unit having installed therein a plurality of predetermined ID codes, said encoding identification unit being electrically connected to said microcontroller and controllable by said microcontroller to recognize the low frequency communication signal received by said LF receiver and to fetch and modulate one respective said ID code for transmission to an electronic control unit in a vehicle by said RF transmitter to let the smart tire pressure sensor establish communication with said electronic control unit; and
an accelerometer sensor electrically connected to said microcontroller and adapted for sensing an acceleration value of said tire and stopping said encoding identification unit from operation upon detection of said acceleration value.

2. The smart tire pressure sensor as claimed in claim 1, further comprising a temperature sensor electrically connected to said microcontroller and adapted for sensing the temperature value of said tire.

3. The smart tire pressure sensor as claimed in claim 1, wherein said encoding identification unit comprises a decoder adapted to amplify and digitalize said low frequency communication signal.

4. The smart tire pressure sensor as claimed in claim 3, wherein said encoding identification unit further comprises a microprocessor and a data bank, said data bank having stored therein said predetermined ID codes, said microprocessor being adapted to recognize the waveform of an inputted digital signal and to fetch a corresponding ID code from said data bank subject to the recognized waveform.

5. The smart tire pressure sensor as claimed in claim 4, wherein said encoding identification unit further comprises an encoder adapted to encode the ID code fetched by said microprocessor from said data bank.

6. A smart tire pressure monitoring system, comprising:
an electronic control unit installed in a vehicle and having electrically connected thereto a plurality of LF antennas and RF receivers;
at least one smart tire pressure sensor respectively installed in one respective tire of said vehicle for communication with said electronic control unit through a wireless communication protocol, each said smart, tire pressure sensor comprising a microcontroller;
wherein each said smart tire pressure sensor further comprises a LF receiver electrically to said microcontroller and adapted for receiving a low frequency communication signal from one said LF antenna, and an encoding identification unit electrically connected to said microcontroller and having installed therein a plurality of predetermined ID codes, said encoding identification unit being controllable by said microcontroller to recognize the low frequency communication signal received by said LF receiver and to fetch and modulate one respective said ID code for transmission to said electronic control unit through a RF transmitter to establish communication between the respective said smart tire pressure sensor and said electronic control unit.

7. The smart tire pressure monitoring system as claimed in claim 6, wherein each said smart tire pressure sensor further comprises an accelerometer sensor electrically connected to said microcontroller and adapted for sensing an acceleration value of said tire and stopping said encoding identification unit from operation upon detection of said acceleration value.

8. The smart tire pressure monitoring system as claimed in claim 6, wherein each said smart tire pressure sensor further comprises a temperature sensor electrically connected to said microcontroller and adapted for sensing the temperature value of said tire.

9. The smart tire pressure monitoring system as claimed in claim 6, wherein said encoding identification unit comprises a decoder adapted to amplify and digitalize said low frequency communication signal.

10. The smart tire pressure monitoring system as claimed in claim 9, wherein said encoding identification unit further comprises a microprocessor and a data bank, said data bank having stored therein said predetermined ID codes, said microprocessor being adapted to recognize the waveform of an inputted digital signal and to fetch a corresponding ID code from said data bank subject to the recognized waveform.

11. The smart tire pressure monitoring system as claimed in claim 10, wherein said encoding identification unit further comprises an encoder adapted to encode the ID code fetched by said microprocessor from said data bank.
